(19) United States
(12) Patent Application Publication
(10) Pub. No.: US 2004/0081196 A1
(43) Pub. Date: Apr. 29, 2004

(54) Protocol independent hub

(76) Inventor: Stephen J. Elliott, Sacramento, CA (US)

Correspondence Address: HEWLETT-PACKARD COMPANY, Intellectual Property Administration, P.O. Box 272400, Fort Collins, CO, 80527-2400, US

(21) Appl. No.: 10/282,678

(22) Filed: Oct. 29, 2002

(51) Int. Cl. H04J 3/16

(52) U.S. Cl. 370/465

(57) ABSTRACT

A protocol independent hub includes a controller allowing for programmable configuration and testing of ports of the hub. Separate programming and testing of each of the ports provides an interface having any protocol to any protocol connectivity. Each of the ports of the protocol independent hub is configured for selectable operation in connection with one of a plurality of network types, with each of the plurality of ports independently programmable for operation in connection with the selected network type.

### FIELD OF THE INVENTION

The present invention relates generally to devices for controlling data traffic, and more particularly to a protocol independent hub.

### BACKGROUND OF THE INVENTION

Data traffic between different devices and/or different points, for example within a network, is controlled by different data communication devices operating to transfer the data. The data is usually configured as data packets for transmission from a source to a destination. In particular, a hub, which typically includes one or more data switches, provides for redirection of data traffic. The hub receives and transmits data traffic between a plurality of points, with the switches controlling (i.e., selecting) the data paths or circuits for transmitting data to its next destination. The switch may also provide router functionality to determine the next point for transmission of data, or such functionality may be separately provided by a router.

Known hubs typically include a plurality of ports requiring protocol conversion in order to control data traffic between devices connected thereto. This protocol conversion that occurs within the hubs in order to route data based on addressing that is imbedded within the protocol layer adds complexity and cost to the hubs. In particular, a separate controller, which may be configured as an application-specific integrated circuit (ASIC), is required at each port of the hub to provide protocol conversion. Further, when communicating data between devices connected to the ports, typically only one port provides communication from the data source and only one port provides communication to the data target. This limits port resources and the flexibility of the hub.

Further, for high speed applications (e.g., Fibre Channel communications), switches within these hubs are typically within the mid-range to upper range, further limiting their applications. For example, mid-range applications may include an ASFC of moderate complexity that is used for each port and typically will decode the protocol-dependent routing. Upper range applications include, for example, an AIC used to route the data traffic at each port and that is capable of handling protocols within a particular technology set such as Fibre-Channel AL port and N port, but that is limited, for example, to E-ports or separate Ethernet. These limitations result because the ASICs providing the protocol functionality at the ports have intelligence to identify “known” versus “unknown” protocols and to reject “unknown” protocols. However, and for example, with Ethernet and Fibre-Channel moving to a common physical layer implementation (e.g., for 10 Gigabit operation), and to a degree that the 1Gb/s and 2Gb/s physical layer components are very similar, and in some cases, compatible, such limitations becomes even more problematic.

Further, and in the case of Fibre-Channel technology, an end-user who simply requires connectivity for Ethernet and Fibre-Channel or iSCSI has a confusing mix of technologies to integrate. As recognized by the inventor hereof, known hubs do not provide a unified approach to routing and security. Further, these known hubs are designed for a particular technology or for specific applications. For example, Fiber-Channel hubs not only have to recover the clock, but also have to interpret the protocol to identify when legitimate traffic is emanating from attached devices or targets.

### SUMMARY OF THE INVENTION

The inventor of the present invention has perceived a need for a protocol independent hub providing any port to any port configurability. The protocol independent hub is generally configured to provide zoning (e.g., hard zoning) to allow the any port to any port configurability.

In one embodiment, a protocol independent hub of the present invention includes a plurality of ports each configured for selectable operation in connection with one of a plurality of network types, with each of the plurality of ports independently programmable for operation in connection with a selected network type. The plurality of network types may include, Ethernet, Fibre Channel, iSCSI and SCSI Over Fibre Channel. Further, each of the ports may include a programmable control unit providing the independent programmable operation. Further, a microcontroller may be provided and configured to allow for programming of at least some of the plurality of programmable control units to provide independent programmable operation of associated ports in connection with the plurality of network types. The plurality of programmable control units may include clock data recovery units and port bypass circuits.

In another embodiment, a protocol independent hub of the present invention includes means for connecting a plurality of devices operating in connection with different network types and means for programmably configuring at least some of the connections between the devices based upon the network type. Further, means for controlling the timing of communication between the devices and means for bypassing at least some of the ports may be provided.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a simplified block diagram of a data hub;

FIG. 2 is a front plan view of a data hub;

FIG. 3 is a block diagram of a controller for a data hub constructed according to the principles of the present invention;

FIG. 4 is a schematic diagram of one embodiment of a controller of the present invention for a data hub;

FIG. 5 is a schematic diagram showing a crosspoint switch of a controller of the present invention for a data hub;

FIGS. 6(a)-6(c) are block diagrams showing different control configurations using the controller of the present invention; and

FIG. 7 is a chart showing designation of specific ports for communication using a crosspoint switch of a controller of the present invention.

### DETAILED DESCRIPTION OF THE PREFERRED EMBODIMENTS

The following description of the preferred embodiments is merely exemplary in nature and is in no way intended to limit the invention, its application, or uses. Thus, although the present invention is described in connection with a hub having particular component parts for providing protocol independent operation, it is not so limited, and additional or different component parts may be implemented.

In general, and as shown in FIG. 1, a hub 20 receives data from a source, with the data typically formatted as data packets, and transmits the data to a destination. The hub 20 may include one or more switches 22 for determining the new destination for the data (e.g., next or final address for the data packets) and directing the data accordingly (e.g., adding new header information to the data packets).

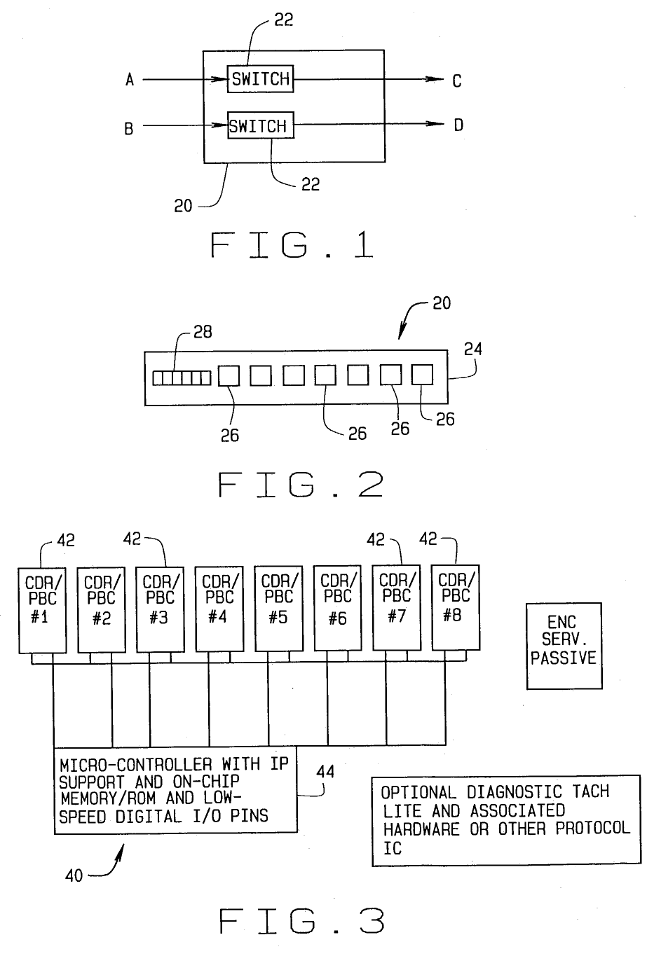

As shown in FIG. 2, the hub 20 typically includes a housing 24 having a plurality of ports 26 for providing connection thereto and between different devices (e.g., two servers connected using a Fibre-Channel link). Other functionality and components may be provided, including for example a status light 28 to indicate hub activity.

Having generally described a hub 20, one embodiment of the present invention, and in particular, a protocol independent hub having multiple ports for connection of devices thereto having different communication requirements is provided. In particular, a controller 40 within the hub 20 as shown in FIG. 3 allows for control of each of the ports 26 to thereby provide the protocol independence. The hub 20 may be zoned using an Ethernet port with a web-GUI or manual interaction as described herein.

Specifically, and as shown in FIG. 3, the controller 40 includes a plurality of Clock Data Recovery Unit/Port Bypass Circuits (Cdr/PBC) components 42 connected to a microcontroller 44. The Cdr and PBC for each of the components 42 are preferably connected by separate communication lines to the microcontroller 44, which may be any suitable controller (e.g., a PowerPC® or Intel® Pentium® on Motorola® 68XXX microprocessor with SIMM slots for variable memory requirements). Embedded UNIX may be used as the operating system.

In one embodiment, the microcontroller 44 includes Internet Protocol (IP) support provided on the chip and on-chip memory (e.g., ROM). The memory may be used to buffer high speed data from a protocol independent decode controller and also may be used to store software, operating system and configuration information. In this embodiment, low-V digital I/O pins are provided to control each of the ports 26. In operation, 3.3 v signals are used to enable or disable the light output of SFP ports as described herein depending on whether it is included in the hard zone. If not, a corresponding LED can give an appropriate indication and the laser light, for use in optical communications, can be turned off.

Each of the Clock Data Recovery Unit/Port Bypass Circuit (Cdr/PBC) components 42 is associated with a different one of the ports 26 for control and zoning thereof. In one embodiment, a total of eight ports are provided, with four small form-factor pluggable (SFP) ports, which may be copper or optical, and four gigabit interface converter (GBIC) ports, which are each separately configurable using the microcontroller 44. The high-speed signals are interpreted using protocol independent decode logic as described herein and the low speed signals are controlled by a low speed control/interpret programmable logic device (PLD) as described herein.

A direct interface between, for example, SFP and GBIC devices without any conversion requirements is provided. Further, such an interface is Fibre-Channel compliant. For example, if four GBIC ports are substituted for four SFP ports, the larger GBICs can interface to the smaller SFPs, facilitating SFP/GBIC interface. This is also compatible with a crosspoint configuration that provides any-to-any compatibility as described herein. This use of an interface between SFP and GBIC is Fibre-Channel compliant because the unit operates at the physical layer and does not interfere with the upper level protocol.

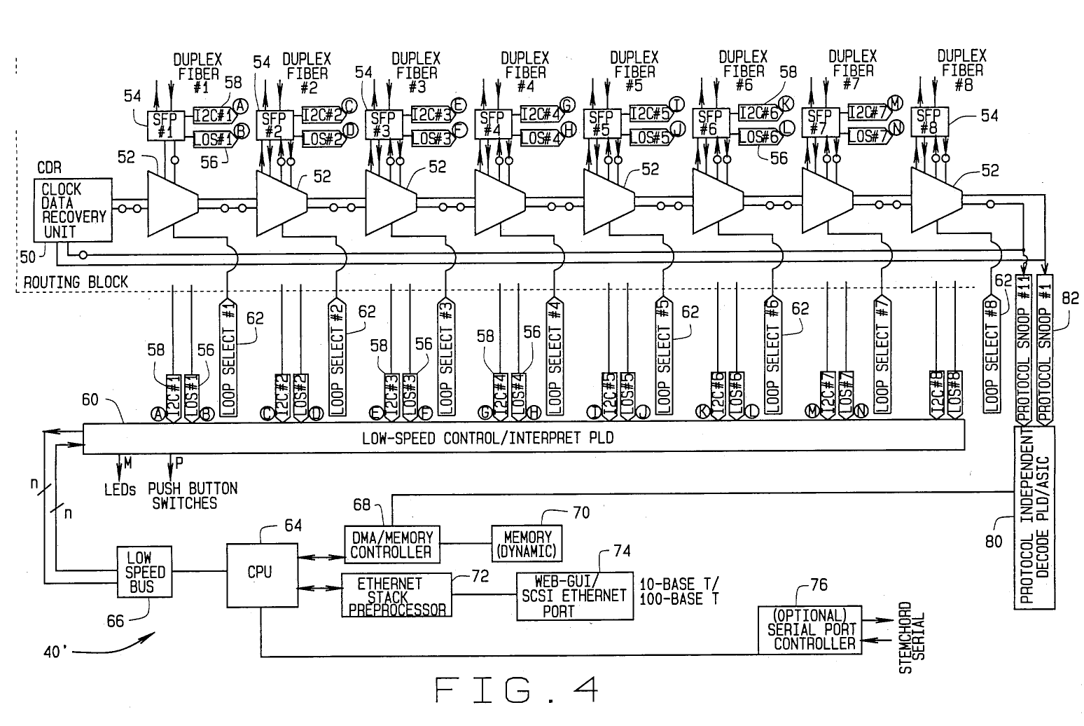

Specifically, and in another embodiment of a controller 40′ as shown in FIG. 4, a single Cdr 50 is provided in connection with a plurality of port bypass buffers 52, which may be configured as multiplexed devices. A separate port bypass buffer 52 is associated with each of the ports 26. Each of the port bypass buffers 52 is connected to a port 26, which as shown is configured as a small form pluggable (SFP) port 54 (e.g., SFP optical transceiver). Each of the SFP ports 54 is provided with a Loss of Signal (LOS) interface 56 and an Inter-IC (12C) interface 58. It should be noted that the letter designations within FIG. 4 identify the same LOS or 12C interface for a particular SFP port 54.

Each of the LOS interfaces 56 and 12C interfaces 58 are connected to a low-speed control/interpret PLD 60 having a plurality of loop select lines 62, one for selecting each of the SFP ports 54. The low-speed control/interpret PLD 60 is connected to a CPU 64 through a low speed bus 66. The CPU 64 is provided with a memory controller 68 for controlling memory 70, which may be provided as part of the CPU 64 (e.g., integrated on-chip). The CPU 64 also may be connected to an Ethernet processor 72, which may be provided as part of the CPU 64 (e.g., integrated on-chip). The Ethernet processor 72 allows for control of the CPU 64 to thereby control the controller 40′ (e.g., program the ports 26) using, for example, a web-GUI 74. Further, a serial port controller 76 may also be provided in connection with the CPU 64 for providing control using an external device (e.g., standalone computer).

A protocol independent decode controller 80 is connected to the CPU 64 through the memory controller 68 and is also connected to one or more of the port bypass buffers 52 for providing control thereof. The protocol independent decode controller 80 also includes one or more protocol snoop interfaces 82 for accessing the port bypass buffers 52 to obtain communication information therefrom (e.g., access the data line to obtain operation information for a device connected to the associated port 26).

Referring now to the Cdr 50, it is a clock data recovery unit. In operation, a clock is recovered from the data using digital phase feedback and analog phase feedback. In the case of the analog approach, the fundamental frequency is identified using known passive or adaptive analog design techniques. In the digital approach, the bit error rate is measured and minimized by introducing a discrete set of delays. Essentially, the Cdr 50 is used to retime signals to reduce jitter, for example, to adjust for timing variations at the edges of the data signals.

The port bypass buffers 52 are each configured for selection using the associated loop select line 62. For example, when a logic high signal is provided by one of the loop select lines 62, the corresponding port bypass buffer 52 is selected and the controller 40′ receives data from the SFP port 54 associated with the particular port bypass buffer 52. Essentially, the SFP port 54 converts high speed electrical signals to high speed optical signals and vice versa. Upon selection of a particular port bypass buffer 52, the LOS interface 56 can be accessed to determine if a device is plugged into the associated SFP port 54 and functioning properly. Further, the 12C interface 58 can be accessed to determine the light strength (i.e., optical light strength) at the associated SFP port 54 to determine if sufficient optical power is present for communication.

It should be noted that additional ports 26 and types of ports may be provided in connection with the hub 20 and controlled by the controllers 40 and 40′. For example, sixteen ports 26 may be provided with eight small form-factor pluggable (SFP) ports 54 and eight gigabit interface converter (GBIC) ports. Other configurations may include a four-port variation, a variation with no protocol independent decode logic, a 10 Gbit per second variation and a simplified variation without any LEDs.

Additional components may be provided in connection with the controller 40, including, for example, a Tach Lite and associated hardware or other protocol IC. The protocol ICs function to interpret the protocol layers to allow the CPU 64 to identify situations requiring rerouting of the low-speed control lines. The CPU 64 with a protocol independent protocol IC (e.g., addressing all the protocols, including gigabit Ethernet, iSCSI, and Fibre-Channel) can be used to provide limited routing functionality. Enclosure services may be provided and can attach as an iSCSI/fiber channel status reporting unit that operates with both protocols to facilitate device reporting (e.g., as displayed on the web-GUI 74).

In operation, the controller 40′ uses the protocol independent decode controller 80 to determine diagnostic information relating to devices connected to the SFP ports 54. For example, using the protocol snoop interfaces 82, a determination may be made as to whether a particular device is functioning properly using the LOS interface 56 and 12C interface 58, or to determine specific communication requirements for that device. This information may be accessed and modifications (e.g., reprogramming an SFP port 54) performed using the web-GUI 74 operating in connection with the CPU 64. Thus, a user can monitor the hub 20 using the controller 40′ to determine if various devices are functioning properly or to determine specific characteristics (e.g., via diagnostic testing) of the devices. For example, schematic diagrams of the devices connected to each of the SFP ports 54 may be provided and displayed on the web-GUI 74 to identify and resolve device problems (e.g., communication problems or to provide rezoning or retiming of signals). It should be noted that the protocol independent decode controller 80 may be implemented in any desired manner as would be appreciated by one skilled in the art. Further, the programming necessary to provide a web-GUI 70 running as part of the CPU 64 may be implemented in any desired manner, for example, using different programming scripts, as would be appreciated by one skilled in the art.

As shown in FIG. 4, a single loop connected to each of the port bypass buffers 52 via the Cdr 50 is provided for configuring the SFP ports 54 to a particular protocol (e.g., Ethernet, Fibre-Channel GBIC or iSCSI). In an alternate embodiment as shown in FIG. 5, a crosspoint switch configuration 90 may be provided to allowing for zoning of the SFP ports 54 for use in connection with different protocols. Specifically, zoning is generally provided using “hard zoning” or “soft-zoning”. Hard zoning is a configuration of the hardware that physically prevents one channel from accessing another channel. “Soft-zoning” is interpretation of the embedded protocol to determine what routing is permitted and what routing is not permitted. The hard zoning is provided in a loop topology as shown in FIG. 4. Using the crosspoint switching technology shown in FIG. 5, soft-zoning may be provided.

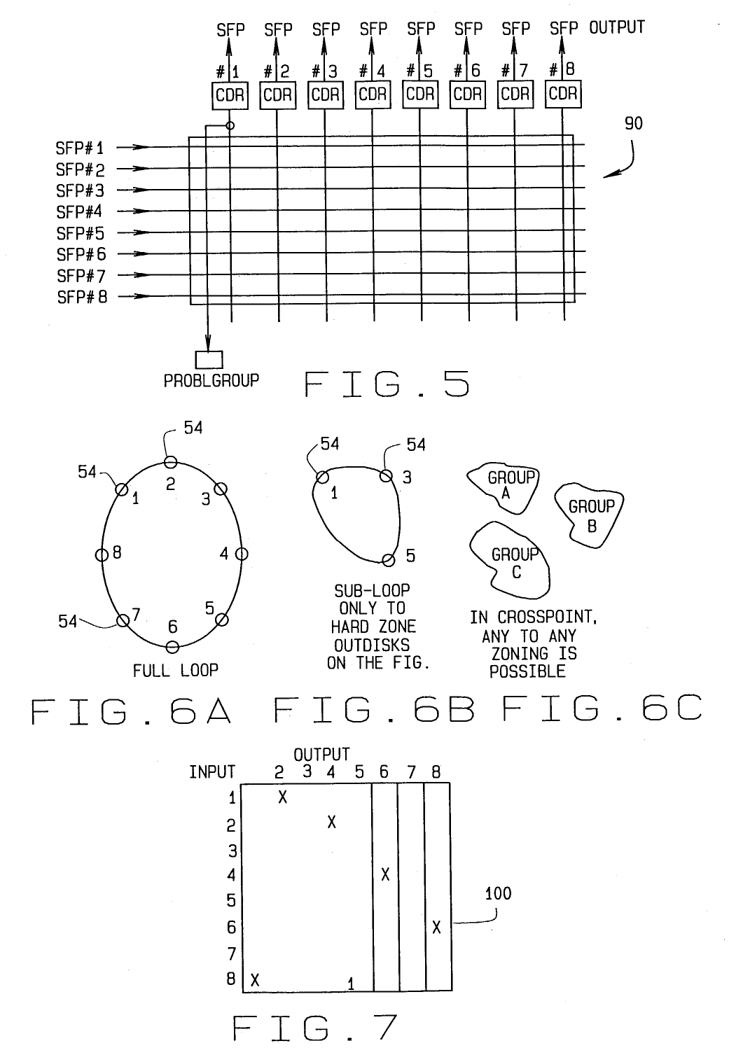

For example, as shown in FIG. 6(a), every SFP port 54 is configured for the same protocol using a full loop provided by the controller 40′ as shown in FIG. 4. Further, and as shown in FIG. 6(b), a sub-loop may be provided to hard zone only specific SFP ports 54 using the controller 40′ (e.g., SFP port numbers 1, 3 and 5). Using the crosspoint switch configuration 90 shown in FIG. 5, any to any zoning of the SFP ports 54 as shown in FIG. 6(c) may be provided. In particular, in this configuration, a selection is made as to which inputs connect to which outputs. This selection may be provided electronically using the web-GUI 74 to select the specific SFP ports 54 using a port selection chart 100 as shown in FIG. 7. As shown therein, the “X” designates the input and outputs that are connected together, thereby providing zoning and allowing protocol independent communication (e.g., specifying the communication protocol separately for each of the connected inputs and outputs).

Further, and with respect to the web-GUI 74, it can operate using Simple Network Management Protocol (SNMP) traps and management to configure sub-loops for security as shown in FIGS. 6(a)-6(c). For example, the web-GUI 74 may operate as an html and/or Java server that interfaces with an HTML browser through the Ethernet port using the Ethernet processor 72 to present a web-page to configure a device connected to an SFP port 54. Additionally, with iSCSI or Ethernet using secure web page access, each SFP port 54 can be associated with a security file. When the security file is opened under the secure Ethernet interface, then access to the loop member (i.e., particular SFP ports 54 identified therewith) is allowed in a secure configuration. The protocol independent decode controller 80 can be used to snoop on the various protocol streams and lock out unsecure data if necessary.

Further, it should be appreciated that a separate processing unit (e.g., CPU 64 in connection with protocol independent decode controller 80 and low-speed control/interpret PLD) provides routing objectives on a multi-protocol basis. In particular, and with respect to, for example, optoelectronic interface technologies, low-speed signals are provided that indicate loss-of-light. These low-speed signals can be routed to the CPU 64 for processing using the protocol independent decode controller 80.

In operation the controllers 40 and 40′ provide a protocol independent hub 20 that is port by port configurable. For example, in a crosspoint application where both Ethernet and Fibre-Channel use the same hub 20, Ethernet uses Ethernet configured ports 26 and Fibre-Channel uses Fibre-Channel configured ports 26. Zoning is this case is provided using the crosspoint switch configuration 90 shown in FIG. 5, which allows any-to-any connectivity at multi-gigabit rates. For example, the connections may be implemented using a 24-bit low-speed digital signal that consists of eight three-bit numbers describing the output to which each of the inputs connects. Any to any connectivity provides that any input can connect to any output. Thus, instead of rewiring cables, these routes can be electronically selected as shown in FIG. 7 and described herein.

Thus, the present invention provides a protocol independent hub that is easy to use and supports connection of devices having high speed operation (e.g., Fibre Channel devices). Further, the hub provides any port to any port configurability with a crosspoint switch configuration that is programmable, resulting in any to any connectivity accessible and programmable by, for example, a Local Area Network (LAN). Bandwidth utilization also may be increased using the hub 20 and controllers 40 and 40′ in connection with a two gigabyte (GB) link by allowing multiple two GB devices that do not consume all of the bandwidth for the link to be connected together. Testing on the fly that does not interfere with the communication protocol is also provided. For example, the protocol independent decode controller 80 may be used to occasionally probe the hub 20 to detect critical failures to report these on the web-GUI 74 on SNMP events/traps.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A protocol independent hub comprising:
a plurality of ports each configured for selectable operation in connection with one of a plurality of network types, with each of the plurality of ports independently programmable for operation in connection with a selected network type.

2. The protocol independent hub according to claim 1 wherein the plurality of network types comprise Ethernet, Fibre Channel, iSCSI, and SCSI over Fibre Channel.

3. The protocol independent hub according to claim 1 wherein each of the ports comprises a programmable control unit providing the independent programmable operation.

4. The protocol independent hub according to claim 3 further comprising a microcontroller configured to allow for programming of at least some of the plurality of programmable control units to provide independent programmable operation of associated ports in connection with the plurality of network types.

5. The protocol independent hub according to claim 3 wherein the plurality of programmable control units comprise clock data recovery units.

6. The protocol independent hub according to claim 3 wherein the plurality of programmable control units comprise port bypass circuits.

7. The protocol independent hub according to claim 4 wherein the microcontroller is configured to provide IP operation.

8. The protocol independent hub according to claim 4 wherein the microcontroller comprises a memory component.

9. The protocol independent hub according to claim 8 wherein the microcontroller comprises low-speed inputs and outputs.

10. The protocol independent hub according to claim 2 wherein at least some of the ports are SFP ports and at least some of the ports are GBIC ports.

11. The protocol independent hub according to claim 1 further comprising a protocol independent decode controller.

12. The protocol independent hub according to claim 3 wherein the plurality of programmable control units comprise SFP ports.

13. The protocol independent hub according to claim 3 wherein the plurality of programmable control units comprise loss of signal and 12C interfaces.

14. The protocol independent hub according to claim 4 further comprising a low-speed control/interpret PLD.

15. A protocol independent hub comprising:
means for connecting thereto a plurality of devices operating in connection with different network types; and
means for programmably configuring at least some of the connections between the devices based upon the network type.

16. The protocol independent hub according to claim 15 further comprising means for storing information relating to the network type in connection with which a device operates.

17. The protocol independent hub according to claim 15 further comprising means for controlling the timing of communication between the devices.

18. The protocol independent hub according to claim 15 further comprising means for bypassing at least some of the ports.

19. The protocol independent hub according to claim 15 further comprising means for providing IP communication between the devices.

20. The protocol independent hub according to claim 15 wherein the means for connecting comprises means providing SFP connections and means providing GBIC connections.

21. The protocol independent hub according to claim 15 wherein the means for programmably configuring at least some of the connections is configured for low-speed input and output operation.

22. The protocol independent hub according to claim 15 further comprising means for protocol independent decoding.

23. A method of providing protocol independent data communication between a plurality of devices comprising:
establishing a connection between at least some of the plurality of devices; and
configuring independently connections between the at least some of the plurality of devices based upon a network type for each of the plurality of devices.

24. The method according to claim 23 further comprising storing information relating to the network types in connection with which the devices operate.

25. The method according to claim 23 further comprising configuring at least some of the connections as SFP connections and configuring at least some of the connections as GBIC connections.

26. The method according to claim 23 wherein the step of configuring independently comprises programmably configuring communication links providing the connections between the plurality of devices based upon a network type.

27. The method according to claim 23 further comprising providing timing signals for use in providing communication between the connected devices.

28. The method according to claim 23 further comprising testing the connection between the plurality of devices.

29. The method according to claim 23 further comprising decoding the network requirements of the plurality of devices.
